(19) United States
(12) Patent Application Publication
(10) Pub. No.: US 2026/0361497 A1
(43) Pub. Date: Nov. 12, 2026

(54) PHYSICAL LAYER CONVERGENCE PROTOCOL DATA UNIT FORMAT AND OPTIMIZED DATA TONE PLAN FOR CHANNEL ACCESS

(71) Applicant: Intel Corporation, Santa Clara, CA (US)

(72) Inventors: Juan Fang, Portland, OR (US); Qinghua Li, San Ramon, CA (US); Laurent Cariou, Milizac (FR); Cheng Chen, Bentonville, AR (US); Yoav Eisenberg, Yehud-Monosson (IL); Danny Alexander, Neve Efraim Monoson (IL); Ratnesh Kumbhkar, Sunnyvale, CA (US); Ehud Reshef, Kiryat Tivon (IL); Hila Ben Artzi, Herzliya (IL); Uri Perimutter, Holon (IL); Chen Kojokaro, Yoqneam Illit (IL); Oren Ezra Avraham, Givat Shmuel (IL)

(21) Appl. No.: 19/630,339

(22) Filed: Mar. 26, 2026

Related U.S. Application Data
(60) Provisional application No. 63/778,977, filed on Mar. 27, 2025.
(60) Provisional application No. 63/841,124, filed on Jul. 9, 2025.

(51) Int. Cl. H04L 5/00

(52) U.S. Cl. CPC H04L 5/0053; H04L 5/0023; H04L 5/0041; H04L 5/0094

(57) ABSTRACT

This disclosure describes systems, methods, and devices related to optimized PPDU format. A device may generate a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG includes a Universal Signal (U-SIG) field and an IMMW-SIG field. The device may cause to send the PPDU to one or more station (STA) devices.

### CROSS-REFERENCE TO RELATED APPLICATION(S)

This application claims the benefit of U.S. Provisional Application No. 63/778,977, filed Mar. 27, 2025, and U.S. Provisional Application No. 63/841,124, filed Jul. 9, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for optimized physical layer (PHY) convergence protocol data unit (PPDU) format, in accordance with one or more example embodiments of the present disclosure.

FIGS. 2-7 depict illustrative schematic diagrams for optimized PPDU format, in accordance with one or more example embodiments of the present disclosure.

FIG. 8 illustrates a flow of a process for an illustrative optimized PPDU format system, in accordance with one or more example embodiments of the present disclosure.

FIG. 9 illustrates a functional diagram of an exemplary communication station that may be suitable for use as a user device, in accordance with one or more example embodiments of the present disclosure.

FIG. 10 illustrates a block diagram of an example machine upon which any of one or more techniques (e.g., methods) may be performed, in accordance with one or more example embodiments of the present disclosure.

FIG. 11 is a block diagram of a radio architecture in accordance with some examples.

FIG. 12 illustrates an example front-end module circuitry for use in the radio architecture of FIG. 11, in accordance with one or more example embodiments of the present disclosure.

FIG. 13 illustrates an example radio IC circuitry for use in the radio architecture of FIG. 11, in accordance with one or more example embodiments of the present disclosure.

FIG. 14 illustrates an example baseband processing circuitry for use in the radio architecture of FIG. 11, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Wi-Fi 9 is positioned as the forthcoming evolution in wireless technology, building upon the advancements of Wi-Fi 8 (802.11bn). The primary objectives for Wi-Fi 9 will align with those established for Wi-Fi 8, focusing on enhancing the reliability of wireless connections, maintaining consistent low latency, and expanding network capacity. However, Wi-Fi 9 aims to push these goals even further, delivering measurable improvements over previous generations. This includes addressing challenges related to operating in unlicensed spectrum shared by numerous legacy devices and technologies, as well as exploring new spectrum opportunities, such as those permitted for Ultra-wideband operation, to enable more efficient spectrum sharing and predictable low-latency traffic. By leveraging frameworks like Multi-Link Operation (MLO) and introducing advanced solutions for spectrum management, Wi-Fi 9 is expected to set new standards for performance, reliability, and efficiency in wireless communications.

IEEE 802.11bq is created to integrate the millimeter wave to the IEEE 802.11. It is desired that the existing 802.11 PPDU format can be reused as much as possible to minimize the implementation complexity.

IEEE 802.11bq was created to integrate millimeter wave technology into the IEEE 802.11 standard several PPDU formats for 802.11bq, based on the existing 802.11 PPDU format, were proposed. In this disclosure, a new, simplified PPDU format for 802.11bq featuring the data tone plan is introduced.

Example embodiments of the present disclosure relate to systems, methods, and devices for 11bq PPDU format design.

IEEE 802.11bq is created to integrate the millimeter wave to the IEEE 802.11. It is desired that the existing 802.11 PPDU format can be reused as much as possible to minimize the implementation complexity. In this disclosure, several PPDU format for the 802.11bq are proposed.

Example embodiments of the present disclosure relate to systems, methods, and devices for IEEE 802.11bq (“0.11bq”) PPDU format design 2 and data tone plan.

The IEEE 802.11bq standard was developed to integrate millimeter wave technology into the IEEE 802.11 framework. Several PPDU formats for 802.11bq, based on the existing 802.11 PPDU format, were proposed. This disclosure introduces a new, simplified PPDU format for 802.11bq that incorporates the data tone plan.

In one or more embodiments, a device or a system may comprise storage and may be configured to address the growing complexity of high-bandwidth wireless communications. The device may generate a Physical Layer Protocol Data Unit (PPDU) that includes a first short training field (STF), a first long training field (LTF), a signal (SIG) field, an Integrated Millimeter Wave Short Training Field (IMMW-STF), and one or more Integrated Millimeter Wave Long Training Fields (IMMW-LTF). The PPDU may also include a data field and a packet extension if needed. The SIG field may contain a Universal Signal (U-SIG) field and an IMMW-SIG field. The device may then cause the PPDU to be sent to one or more station (STA) devices. This approach may enable efficient and flexible protocol construction, supporting both data transmission and control signaling. For example, the device may assemble a PPDU with all necessary training and signal fields before transmission to ensure compatibility with various station devices.

In one or more embodiments, the device may ensure that the total duration of the IMMW-STF and the IMMW-LTF is approximately 8 microseconds. The IMMW-LTF may be realized as an upclocked version of an existing 20 MHz or 40 MHz 1×, 2×, or 4×HE-LTF, scaled by a factor of 16 for 320 MHz or 640 MHz IMMW PPDU. This scaling may address the challenge of maintaining synchronization and channel estimation accuracy at higher bandwidths. As a result, the device may provide robust performance in demanding environments. For example, the device may upclock a 20 MHz HE-LTF by 16 times, adapting it for use in a 320 MHz IMMW PPDU.

In one or more embodiments, the U-SIG and IMMW-SIG fields may include bandwidth indicators specifying 320 MHz or 640 MHz operation. These fields may contain a length field, which may be the same as that in L-SIG or may indicate the number of OFDM symbols, along with other parameters such as modulation and coding scheme (MCS), coding bit, LDPC extra symbol, 2×LDPC, STA ID, uplink or downlink (UL/DL) indicator, BSS color, PPDU type (such as SU PPDU or NDP), TXOP, guard interval (GI), number of LTFs, scrambling seed, and spatial configuration if MIMO is supported in IMMW. This structure may allow for comprehensive configuration and control signaling. For example, the device may set the bandwidth field to 640 MHz and include a spatial configuration for MIMO support.

In one or more embodiments, the device may support both single user (SU) PPDU and null data packet (NDP) types to accommodate different transmission scenarios. The device may be configured to duplicate the first STF, first LTF, and the U-SIG or IMMW-SIG for every 320 MHz within a bandwidth. This duplication may enhance signal robustness and ensure reliable protocol operation across wide bandwidths. For example, the device may duplicate the U-SIG across each 320 MHz segment in a 640 MHz system.

In one or more embodiments, the device may include a two-bit fine sector search field in the U-SIG, indicating a number of fine sector search symbols from zero to three. The IMMW-SIG field may be transmitted using a fixed MCS, possibly identical to that of the U-SIG field, or a configurable MCS as indicated in the U-SIG. The device may apply different tone plans based on bandwidth, such as using a 20 MHz U-SIG tone plan for sub-7 GHz and duplicating over each 80 MHz in IMMW PPDU, a VHT 40 MHz tone plan over each 160 MHz, or an HE/EHT 256 tone plan over each 320 MHz if the total bandwidth is greater than 320 MHz. These strategies may optimize compatibility and decoding reliability. For example, the device may use a VHT 40 MHz tone plan for a 320 MHz IMMW PPDU, duplicating fields as needed.

In one or more embodiments, the device may map the data field to a 256-point or 512-point FFT non-OFDMA EHT tone plan, with 1.25 MHz subcarrier spacing for 320 MHz or 640 MHz IMMW PPDU data transmission. The U-SIG field may identify the PPDU type as either SU PPDU or NDP using a reserved bit. Additionally, the device may include a Low-Density Parity-Check (LDPC) extra symbol indication bit in the SIG field, based on an LDPC rate matching algorithm. The device may further insert at least one Training (TRN) field for fine sector searching before the data field. These configurations may enhance data integrity and facilitate adaptive error correction. For example, the device may enable LDPC extra symbol indication to match a specific coding rate.

In one or more embodiments, the device may map an LTF sequence over each 80 MHz of a 320 MHz transmission in such a way that subcarriers with indices from −26 to −2 and from 2 to 26 are modulated by elements of a Long (L) sequence, while other subcarriers are set to zero. The device may upclock an existing legacy 20 MHz LTF with the LTF sequence L−26,26 by 4 times and duplicate it over each 80 MHz, resulting in a 2 microsecond duration as the first LTF. This approach may provide accurate timing and frequency estimation under wideband conditions. For example, the device may generate the first LTF for a 320 MHz transmission by upclocking and duplicating the L sequence.

These embodiments may address the technical challenges of scalable, high-bandwidth wireless communication by leveraging field duplication, flexible tone planning, and adaptive training structures. Through these mechanisms, the device may achieve robust synchronization, reliable data transmission, and efficient protocol signaling in next-generation millimeter wave systems. For example, the device may seamlessly transition between SU PPDU and NDP formats, or dynamically adjust the MCS and tone plan to suit the operational environment.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

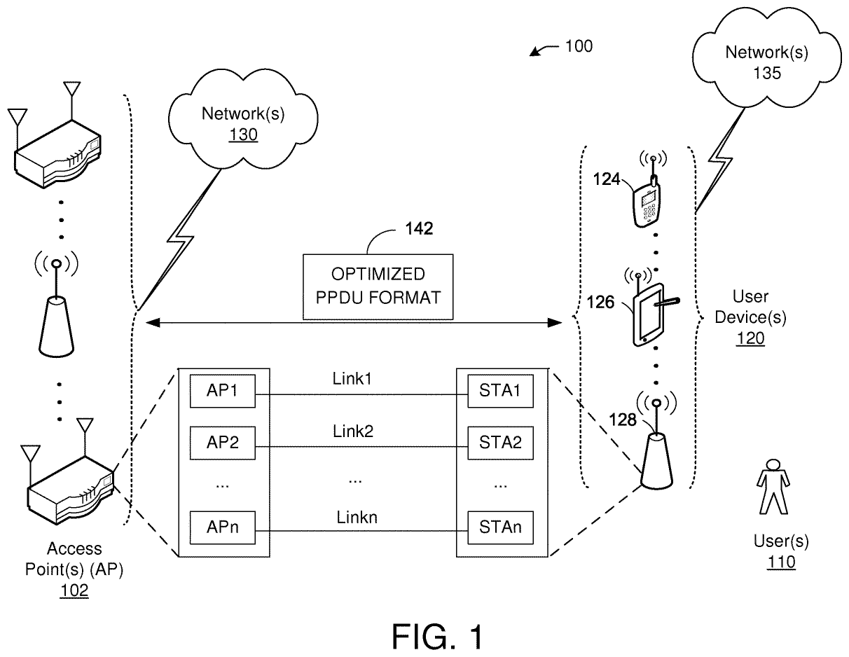

FIG. 1 is a network diagram illustrating an example network environment of optimized PPDU format, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

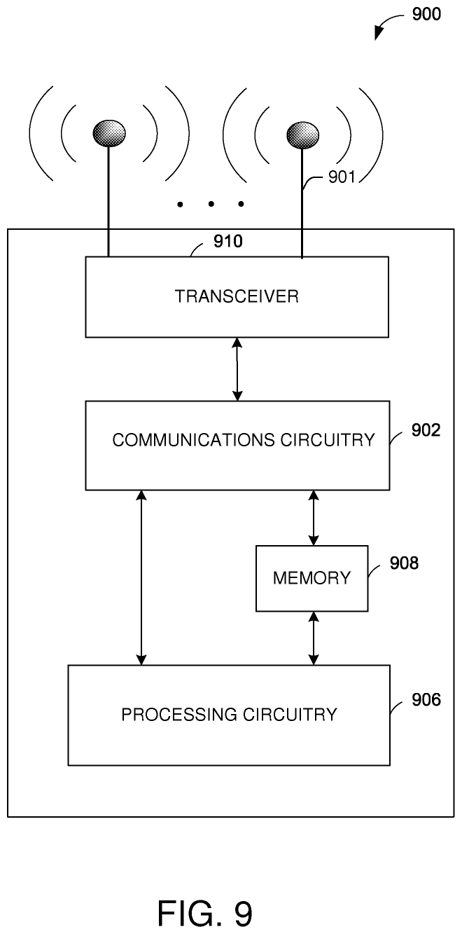

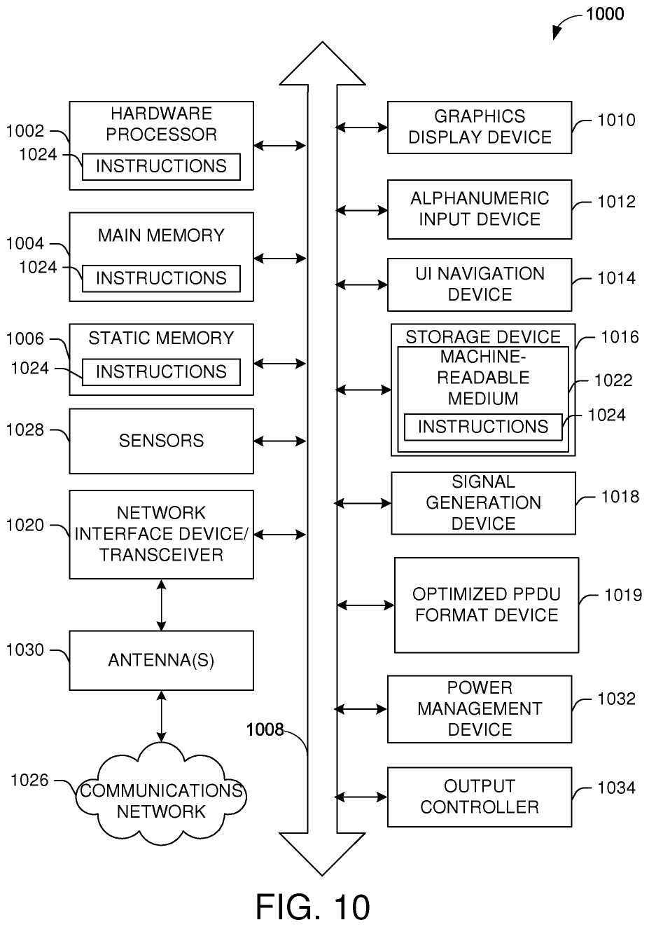

In some embodiments, the user devices 120 and the AP 102 may include one or more computer systems similar to that of the functional diagram of FIG. 9 and/or the example machine/system of FIG. 10.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an optimized PPDU format 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

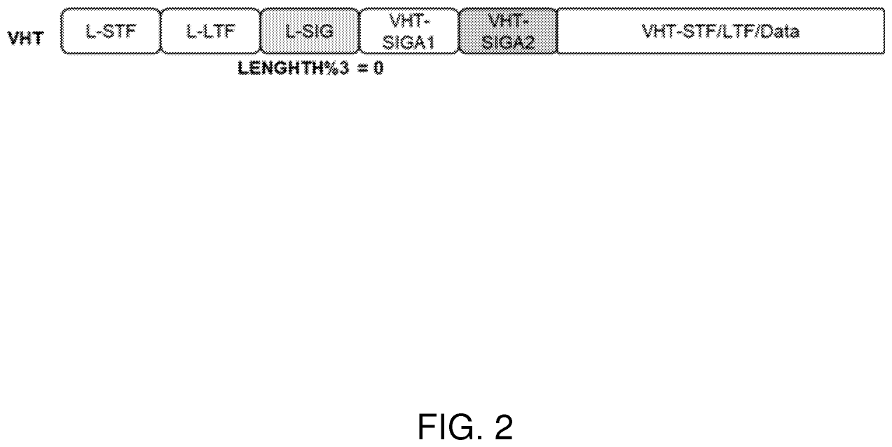

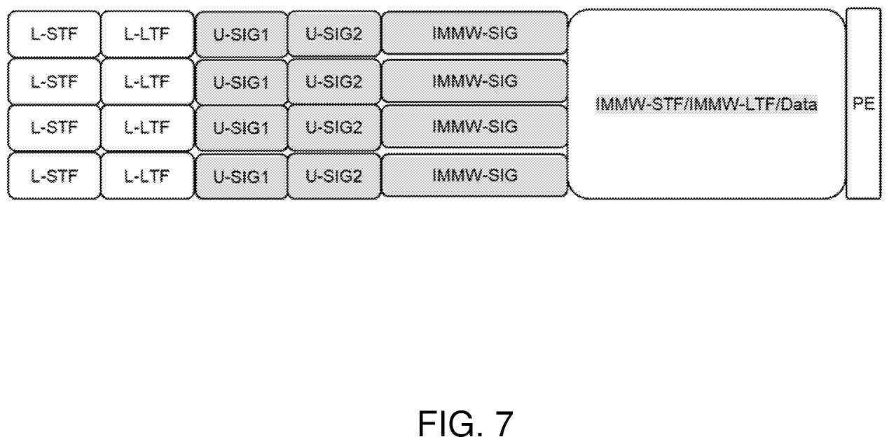

FIGS. 2-7 depict illustrative schematic diagrams for optimized PPDU format, in accordance with one or more example embodiments of the present disclosure.

### Option 1: Reuse Existing VHT PPDU Format for 802.11bq:

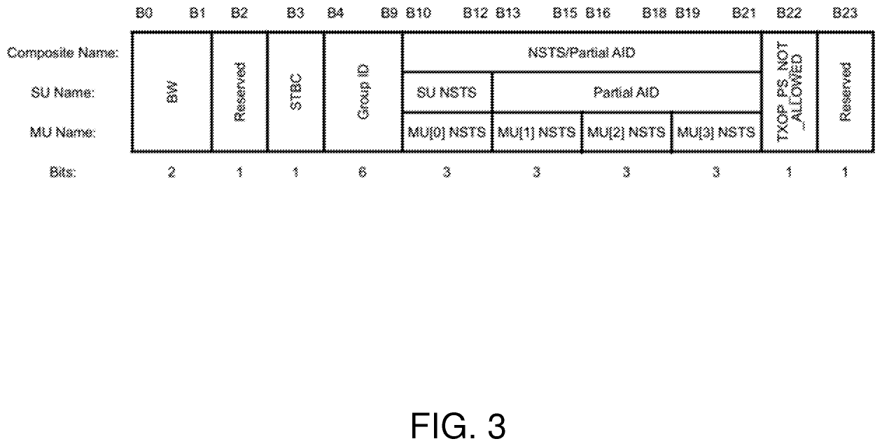

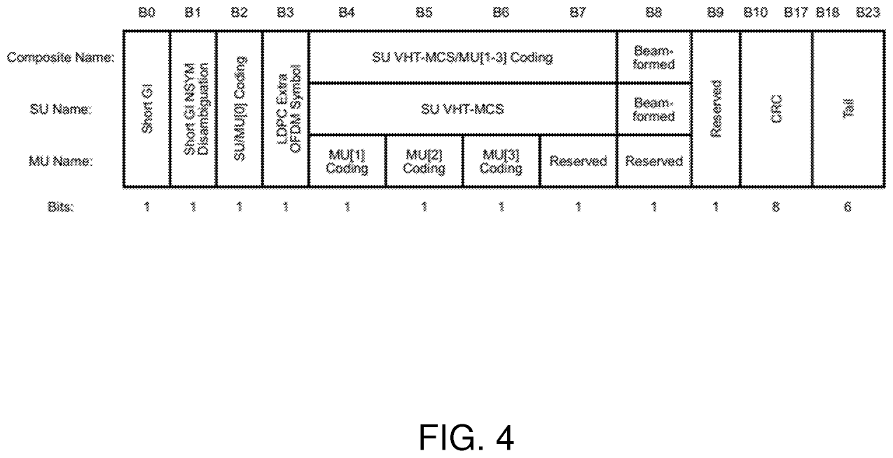

802.11bq will reuse the 802.11ac PPDU format as shown in FIG. 1. Both the preamble and payload will be upclocked by 8 or 4 times. FIGS. 3 and 4 show the structure of VHT-SIG-A1 and VHT-SIG-A2, respectively.

### VHT-SIG-A1:

B0-B1 will indicate the BW, set to 0 for 160 MHz, 1 for 320 MHz, set to 2 for 640 MHz, and 3 for 1280 MHz. Value 0 and or 3 may be reserved if 160 MHz and or 1280 MHz for 802.11bq are not supported. Or set to 0 for 320 MHz, set to 1 for 640 MHz, set to 2 for 1280 MHz and 3 as reserved value.
B2: reserved
B3: STBC, set to 0 for 802.11bq SU.
B4-B9: Group ID, set to 0 or 63 for an 802.11bq SU PPDU.

B10-B21: NSTS/Partial AID, B10-B12 is set to 0 for 1 space-time stream and set to 1 for two space-time streams if two spatial streams are supported in 802.11bq. Otherwise, value of 1 with other values from 2-7 will be kept as reserved value. B13-B21 will be used as Partial AID, which provides an abbreviated indication of the intended recipients of the PSDU.
B22: TXOP_PS_NOT_ALLOWED: kept the same definition.
B23: reserved

### VHT-SIG-A2:

B0: Short GI, set to 0 if short guard internal is not used in the Data field, which is 0.1 μs comparing with the 0.8 μs in VHT. Set to 1 if short guard internal is used in the Data field, which is 0.05 μs comparing with the 0.4 μs in VHT.
B1: same as that in VHT
B2: SU/MU coding: set to 0 for BCC, 1 for LDPC, maybe only LDPC is used for 802.11bq.
B3: LDPC extra OFDM symbol: same definition as that in VHT
B4-B7: SU VHT_MCS/MU Coding: for a VHT SU PPDU it is the VHT-MCS index. It may redefine to carry the new MCS defined 802.11bn without higher QAM.
B8: beamformed, kept the same definition.
B9: reserved
B10-B17: CRC
B18-B23: tail

Note: the reserved field or value may be used for 802.11bq indication and the existing field may be updated for 802.11bq indication.

### Option 2: Reuse Existing EHT/UHR PPDU Format as Baseline for 802.11bq:

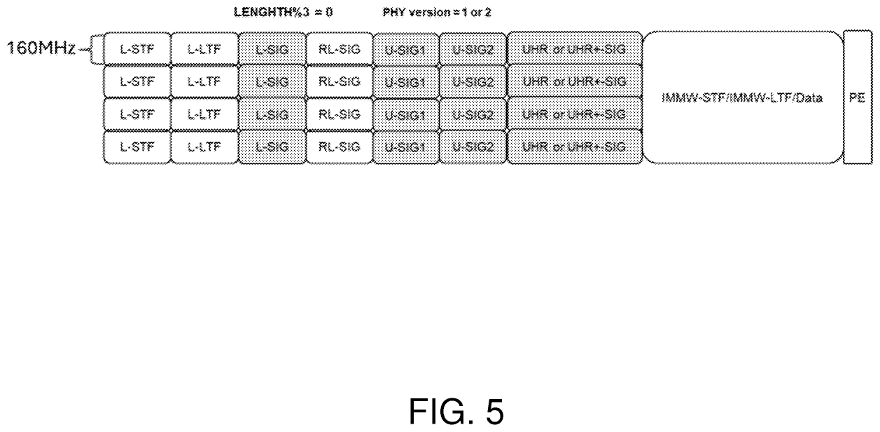

802.11bq will reuse the 802.11be/bn PPDU format as shown in FIG. 5. There are several options, Option 2A, it will include L-STF, L-LTF, L-SIG, RL-SIG, U-SIG1, U-SIG2, UHR/UHR+-SIG, IMMW-STF, IMMW-LTF, IMMW-data and PE. The PHY version may be set to 1 if IMMW is defined before Wi-Fi 9 or set to 2 if IMMW is defined over Wi-Fi 9. IMMW will reuse the U-SIG and UHR/UHR+-SIG format as 802.11bn or Wi-Fi 9 in sub-8 GHz with indication for differentiation. IMMW-STF and IMMW-LTF may be existing before the data part if wider bandwidth or multiple spatial stream is used and/or packet acquisition and initial channel estimation is done over the primary 160 MHz. The preamble until UHR or UHR+SIG will be upclocked by 8 or 4 times. And the IMMW-STF, IMMW-LTF, data part will be upclocked by 32 or 16 time comparing with 802.11ax/be/bn data part.

Referring to FIG. 5, there is shown a 640 MHz 802.11bq SU/NDP PPDU format.

The U-SIG1 and U-SIG2 will carry version independent field as that defined in 802.11be/bn, which includes PHY Version, PPDU BW, DL/UL, BSS color and TXOP. The IMMW single user, NDP or TB PPDU can be indicated by some reserved value or bit or validate bit in the U-SIG. One example to indicate IMMW SU, NDP PPDU is by using B0-B2 with value of (0 0 0) in U-SIG 2 of MU-PPDU and indicate IMMW TB PPDU by using B0-B2 with value of (0 0 0) in U-SIG 2 of TB-PPDU. The new added BW for IMMW PPDU comparing with 802.11bn, such as, 320 MHz, 640 MHz and 1280 MHz will be indicated through validate value by the bandwidth field in the U-SIG1. 160 MHz bandwidth can be indicated as in sub-8 GHz. Another method is to multiple current BW value by 8 times to indicate the IMMW PPDU BW. For example, value of 0, 1, 2, 3 in sub-8 GHz is used to indicate 20 MHz, 40 MHz, 80 MHz, 160 MHz it will be used to indicate 160 MHz, 320 MHz, 640 MHz and 1280 MHz in IMMW PPDU. All other fields in current U-SIG and UHR-SIG will be kept the same for IMMW PPDU with some field to be set to fixed value. Such as Spatial reuse field will be fixed to be 15 as disabled.

Option 2B, it will include L-STF, L-LTF, L-SIG, RL-SIG, U-SIG1, U-SIG2, IMMW-SIG, IMMW-STF, IMMW-LTF, IMMW-data and PE. The PHY version may be set to 1 if IMMW is defined before Wi-Fi 9 or set to 2 if IMMW is defined over Wi-Fi 9, it may be set to a reserved value between 2-7 to differentiate IMMW PPDU from sub-8 GHz PPDU. If IMMW transmission share the same PHY version value in Sub-8 GHz, some reserved values, reserved bit or validate bit in the U-SIG can be used to differentiate IMMW PPDU. IMMW-SIG may be added after U-SIG2 to carry overflow parameters for IMMW PPDU transmission. IMMW-STF and IMMW-LTF may be existing before data part. Both the preamble and data part will be upclocked by 8 or 4 times comparing with 802.11 ac, which means the subcarrier spacing of preamble and data part in IMMW PPDU is 2.5 kHz or 1.25 kHz.

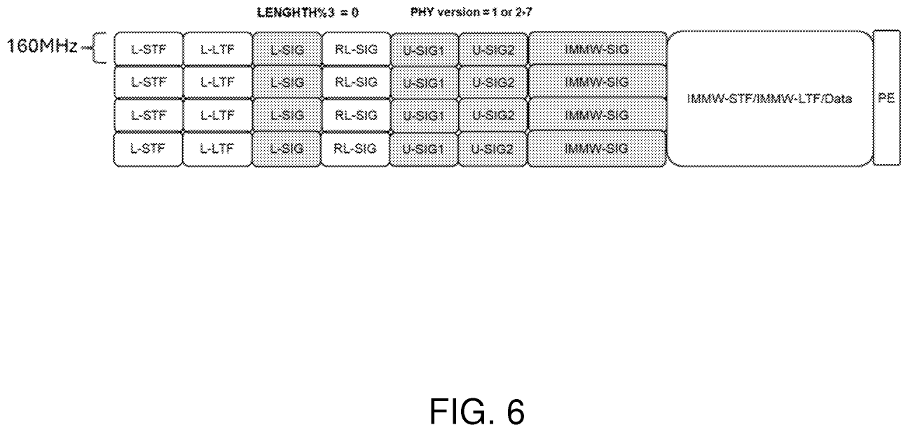

Referring to FIG. 6, there is shown a 640 MHz 802.11bq SU/NDP PPDU format.????

The U-SIG1 and U-SIG2 will carry version independent field as that defined in 802.11be/bn, which includes PHY Version, PPDU BW, DL/UL, BSS color and TXOP. The IMMW single user, NDP or TB PPDU can be indicated by some reserved value or bit or validate bit in the U-SIG if it is not indicated through a dedicated PHY version. One example to indicate IMMW SU, NDP PPDU is by using B0-B2 with value of (0 0 0) in U-SIG 2 of MU-PPDU and indicate IMMW TB PPDU by using B0-B2 with value of (0 0 0) in U-SIG 2 of TB-PPDU. The new added BW for IMMW PPDU comparing with 802.11bn, such as, 320 MHz, 640 MHz and 1280 MHz will be indicated by the validate value of the bandwidth field in the U-SIG1. 160 MHz bandwidth can be indicated as in sub-8 GHz. Another method is to multiple current BW value by 8 times to indicate the IMMW PPDU BW. For example, value of 0, 1, 2, 3 in sub-8 GHz is used to indicate 20 MHz, 40 MHz, 80 MHz, 160 MHz it will be used to indicate 160 MHz, 320 MHz, 640 MHz and 1280 MHz in IMMW PPDU. The U-SIG field may also include the STA-ID, IMMW-MCS, 2×-LDPC coding type, LDPC extra symbol indication, GI type and IMMW-LTF size, or number of spatial streams of the IMMW PPDU. One example U-SIG format for IMMW SU or NDP PPDU is as shown in following Table 1. For simplification, the GI+LTF size, LDPC extra symbol and number of spatial streams may be defined as fixed value.

TABLE 1

| U-SIG1 | B0-B2 | B3-B5 | B6 | B7-B12 | B13-B19 | B20-B24 | B25 |
|---|---|---|---|---|---|---|---|
| | PHY version | PPDU | UL/DL | BSS color | TXOP | IMMW- | Validate/GI |
| | | BW | | | | MCS | type and |
| | | | | | | | LTF size/ |
| | | | | | | | number of |
| | | | | | | | spatial |
| | | | | | | | stream |

| U-SIG2 | B0-B2 | B3-B13 | B14 | B15 | B16-B19 | B20-B25 |
|---|---|---|---|---|---|---|
| | PPDU Type: | STA-ID | 2x | LDPC | CRC | Tail |
| | IMMW | | LDPC | extra | | |
| | SU/NDP(0 0 0) | | | symbol | | |

If the parameters for IMMW PPDU transmission cannot be carried in U-SIG1 and U-SIG2, IMMW-SIG after U-SIG2 will be added to carry the overflow information.

Option 3: PPDU format design for 802.11bq without keeping auto classification for legacy sub-8 GHz PPDU format.

Both the preamble and data part will be upclocked by 8 or 4 times comparing with 802.11ac, which means the subcarrier spacing of the preamble and data part in IMMW PPDU is 2.5 kHz or 1.25 kHz. The 802.11bq preamble consists of L-STF, L-LTF, U-SIG1, U-SIG2, IMMW-SIG, IMMW-STF, IMMW-LTF.

The U-SIG1 and U-SIG2 will carry version independent field as that defined in 802.11be/bn, which includes PHY Version, PPDU BW, DL/UL, BSS color and TXOP, and version dependent fields, which will include PPDU type, Length field, LDPC extra symbol indication, GI and LTF size, per-user information (STA-ID, IMMW-MCS, 2×_LDPC, spatial configuration if more than one spatial stream is supported by IMMW, CRC (4 bits) and tail (6 bits). The order of all fields and number of bits for each field will be defined later. If U-SIG field is not able to carry all the information, IMMW-SIG will be added after the U-SIG2 to carry the overflow information. If IMMG-SIG is defined with multiple MCSs, then IMMW-SIG MCS and number of IMMW-SIG symbols should be indicated in the U-SIG. For Simplicity IMMW-SIG may be transmitted with the same fixed MCS as the U-SIG, then if only SU and NDP mode is defined for IMMW, both IMMW-SIG MCS and number of IMMW-SIG symbols are fixed value and don't need to be indicated in the U-SIG. if IMMW-SIG is transmitted with fixed MCS but MU mode may be defined for IMMW in this generation or future generation, the number of IMMW-SIG symbols still needs to be indicated in the U-SIG field.

The version independent fields may follow the same definition in 802.11be/bn with the PPDU BW definition as following:
Option A: The new added BW for IMMW PPDU comparing with 802.11bn, such as, 320 MHz, 640 MHz and 1280 MHz will be indicated by the validate value of the bandwidth field in the U-SIG1. 160 MHz bandwidth can be indicated as in sub-8 GHz.
Option B: Another method is to multiple current BW value by 8 times to indicate the IMMW PPDU BW. For example, value of 0, 1, 2, 3 in sub-8 GHz is used to indicate 20 MHz, 40 MHz, 80 MHz, 160 MHz it will be used to indicate 160 MHz, 320 MHz, 640 MHz and 1280 MHz in IMMW PPDU.

### PPDU Type:

It may keep the current definition in 802.11be/11bn without extra indication to indicate that it is IMMW SU or NDP PPDU.

It may keep the current definition in 802.11be/11bn and use some reserved value or bit or validate bit in the U-SIG to indicate IMMW SU/NDP/MU/TB IMMW PPDU. One example to indicate IMMW SU, NDP PPDU is by using B0-B2 with value of (0 0 0) in U-SIG 2 of MU-PPDU and indicate IMMW TB PPDU by using B0-B2 with value of (0 0 0) in U-SIG 2 of TB-PPDU. Another example is to use one reserved or validate bit to indicate whether it is IMMW PPDU or not.

LENGTH: it was indicated in the L-SIG in sub-8 GHz band, it shall be carried in the U-SIG or IMMW-SIG, can be indicated as the same way as that in L-SIG or indicated as number of OFDM symbols.

LDPC extra symbol: since the number of coded bit per OFDM symbol is close to 802.11ac and the number of spatial stream is equal 1 or 2, so 802.11ac LDPC rath matching is recommended to be reused in 802.11bq. Then LDPC extra symbol indication bit is needed unless it is fixed to be 1.

GI and LTF size: if more than one GI and LTF size is defined for 802.11bq data ppdu, this field should be indicated in the U-SIG or IMMW-SIG.

### Per-User Information:

STA-ID: identifier of the receiver
IMMW-MCS: modulation and coding scheme. To simplify the design, the current UHR-MCS or EHT-MCS or VHT-MCS indication mapping table can be reused in 802.11bq.
2×_LDPC: indicate whether 2×LDPC is used or not unless 2×LDPC will be used in 802.11bq.
Spatial configuration: if more than one spatial stream and/or MU MIMO is supported in IMMW.

TABLE 2
802.11bq format 1:

| | 0.9, 1, | | | Min 8 usec between IMMW-SIG and DATA | | | | | | |
|---|---|---|---|---|---|---|---|---|---|---|
| 2 or | 1.2, 2 | 1 or 2 | n | 1 or 2 | 1 | 1 | 1 | m | | |
| 4 μs | or 4 μs | symbols | symbols | μs | symbol | symbol | symbol | symbols | | |
| STF | LTF | U-SIG | IMMW- | IMMW- | Fine | Fine | Fine | IMMW- | DATA | PE |
| | | | SIG | STF | sector | sector | sector | LTF | | |
| | | | | | search | search | search | 1, 2, . . . , m | | |
| STF | LTF | U-SIG | IMMW- | IMMW- | Fine | Fine | Fine | | | |
| | | | SIG | STF | sector | sector | sector | | | |
| | | | | | search | search | search | | | |
| STF | LTF | U-SIG | IMMW- | IMMW- | Fine | Fine | Fine | | | |
| | | | SIG | STF | sector | sector | sector | | | |
| | | | | | search | search | search | | | |
| STF | LTF | U-SIG | IMMW- | IMMW- | Fine | Fine | Fine | | | |
| | | | SIG | STF | sector | sector | sector | | | |
| | | | | | search | search | search | | | |

320 MHz IMMW PPDU format.
STF: upclock existing 20 MHz legacy STF by 4 times and duplicate over each 80 MHz, which resulting in 10 times of 0.2 μs periodicity. It may need to extend with more time repetition, such as 20 times of 0.2 μs periodicity.

### LTF:

Option 1: upclock existing legacy 20 MHz LTF with the LTF sequence, L_{-26,26}, defined by equation (17-8) in Draft P802.11REVme_D7.0 by 4 times and duplicate over each 80 MHz; which will result in 2 μs duration.
Option 2: in a 320 MHz IMMW PPDU transmission, the LTF sequence transmitted on subcarrier [−26:26] over each 80 MHz is given by following equation:

LTF_{-26,26}(−26: 2,2: 26)=L_{-26,26}(−26: 2,2: 26), with value of 0 over other subcarriers

It will result in 0.8 μs duration for 2 LTF symbols plus GI, which can be ¼, ½ or 100% as 0.1/0.2/0.4 μs, so the LTF duration would be 0.9/1.0/1.2 μs.

The benefit of this LTF design is to mitigate the phase noise effect on the finer CFO correction and the channel estimation.

The Physical Layer Protocol Data Unit (PPDU) includes a Long Training Field (LTF) modulated by a Long (L) sequence of fifty-three elements, specifically defined as L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}. This sequence is mapped to a grid of subcarriers indexed from −26 to 26, wherein the twenty-seventh element corresponds to a zero value at the direct current (DC) index of 0 to minimize carrier interference. Within an Integrated Millimeter Wave (IMMW) framework, such as a 320 MHz or 640 MHz transmission, this 53-element sequence is duplicated across 80 MHz sub-bands to provide a high-resolution reference for channel estimation. By utilizing this fixed bipolar pattern of phase shifts, the processing circuitry enables the receiving device to synchronize timing and compensate for frequency-selective fading before the transition to upclocked data symbols with 1.25 kHz subcarrier spacing.

U-SIG: U-SIG can be transmitted with existing 20 MHz U-SIG tone over sub-7 GHz plan and duplicate over each 80 MHz in IMMW PPDU, or be transmitted with existing VHT 40 MHz tone plan and duplicate over each 160 MHz in IMMW PPDU, or be transmitted with existing HE/EHT 256 tone plan and duplicate over each 320 MHz in IMMW PPDU if the total bandwidth is larger than 320 Mhz. The subcarrier spacing is 1.25 MHz or 2.5 MHz.

IMMW-SIG: IMMW-SIG can be transmitted with existing 20 MHz U-SIG tone over sub-7 GHz plan and duplicate over each 80 MHz in IMMW PPDU, or be transmitted with existing VHT 40 MHz tone plan and duplicate over each 160 MHz in IMMW PPDU, or be transmitted with existing HE/EHT 256 tone plan and duplicate over each 320 MHz in IMMW PPDU if the total bandwidth is larger than 320 Mhz. The subcarrier spacing is 1.25 MHz or 2.5 MHz.

Note: The U-SIG and IMMW-SIG will be used to carry length field, mcs, coding bit if multiple coding types are going to be used for IMMW data ppdu, these coding types may include BCC, legacy LDPC and 2×LDPC, LDPC extra symbol field if LDPC with 802.11ac LDPC rate matching is used, DL/UL, PHY version, BSS color, STA-ID, PPDU type, TXOP, GI+LTF size and number of IMMW-LTFs, number of Fine sector search fields, which can be but not limited to in terms of number of sectors, best sector ID feedback from the receiver to the transmitter based on the fine sector search result in current PPDU transmission, scrambling seed information and etc. These fields can be separated into version independent and version dependent fields, and the U-SIG and IMMW-SIG maybe can be combined as one SIG field. The scrambling seed can be also carried in the U-SIG or IMMW-SIG to improve the reliability.

An example of “Number of Fine sector search fields” design:
2 bit to indicate the number of fine sector search symbols:
00: no fine sector search symbols.
01: there is one fine sector search symbol.
10: there are two fine sector search symbols.
11: there are three fine sector search symbols.

After the receiver of the current IMMW PPDU find the best Sector ID based on the fine sector search symbols within the IMMW PPDU preamble, the receiver will feedback the best sector ID information in the IMMW-SIG to the transmitter in the following acknowledgement frame. An example of “best sector ID field” design:
2 bit to indicate the best sector ID:
00: the current sector is the best.
01: the sector set in the first fine sector search symbol of received PPDU is the best.
10: the sector set in the second fine sector search symbol of received PPDU is the best.
11: the sector set in the fourth fine sector search symbol of received PPDU is the best.

IMMW-STF: upclock existing legacy STF by 4 times and duplicate over each 80 MHz, which resulting in 10 times of 0.2 μs periodicity. It may need to shorter with less time repetition, such as 5 times of 0.2 μs periodicity.

Fine sector search: this is for Beamforming refining/tuning sector search, which can alternate sector STFs and the number of symbols is indicated in the IMMW-SIG field.

IMMW-LTF: in a 320 MHz IMMW PPDU transmission, the IMMW-LTF sequence transmitted on subcarrier [−122:122] is given by Equation (27-41), Equation (27-42) or Equation (27-43) with subcarrier spacing as 1.25 MHz, which is equivalent to :upclock existing 20 MHz 1× or 2× or 4×HE-LTF by 16 times for 320 MHz IMMW PPDU and duplicate over each 320 MHz if the IMMW PPDU bandwidth is wider than 320 MHz. The IMMW-LTF is optional is MIMO is not used, it can also used to improve the PHY performance.

The benefit of using 1× or 2×ITE-LTF design is to mitigate the phase noise effect on the channel estimation.

DATA: 256/512 802.11ax tone plan will be used to for the 320/640 MHz IMMW PPDU data plan.

256/512 802.11ac tone plan can also be used for the 320/640 MHz IMMW PPDU data plan. But, 802.11ax tone plan is more efficient.

Note: minimum 8 μs is required between the end of U-SIG/IMMW-SIG and the beginning of the first DATA symbol, which is similar to sub-8 GHz case, where there is minimum 8 μs between the end of EHT/UHR-SIG and the beginning of the first DATA symbol. These time duration can be used for fine sector search or to transmit more MI-W-LTFs for more accurate channel estimation. The minimum duration may be a smaller number.

TABLE 3
802.11bq format 2:

| | 0.9, 1 or | | Min 8 usec between IMMW-SIG and DATA | | | | | | |
|---|---|---|---|---|---|---|---|---|---|
| 2 or | 1.2 μs | | | 1 | 1 | 1 | m | | |
| 4 μs | or 2 μs | n symbols | 1 or 2 μs | symbol | symbol | symbol | symbols | | |
| STF | LTF | U- | IMMW- | Fine | Fine | Fine | IMMW- | DATA | PE |
| | | SIG/IMMW- | STF | sector | sector | sector | LTF | | |
| | | SIG | | search | search | search | 1, 2, . . . , m | | |
| STF | | | | Fine | Fine | Fine | | | |
| | | | | sector | sector | sector | | | |
| | | | | search | search | search | | | |
| STF | | | | Fine | Fine | Fine | | | |
| | | | | sector | sector | sector | | | |
| | | | | search | search | search | | | |
| STF | | | | Fine | Fine | Fine | | | |
| | | | | sector | sector | sector | | | |
| | | | | search | search | search | | | |

320 MHz IMMW PPDU format.

STF: upclock existing legacy STF by 4 times and duplicate over each 80 MHz, which resulting in 10 times of 0.2 μs periodicity. It may need to extend with more time repetition, such as 20 times of 0.2 μs periodicity.

LTF: in a 320 MHz IMMW PPDU transmission, the LTF sequence transmitted on subcarrier [−122:122] is given by Equation (27-41), Equation (27-42) or Equation (27-43) with subcarrier spacing as 1.25 MHz, which is equivalent to :upclock existing 20 MHz 1× or 2× or 4×HE-LTF by 16 times for 320 MHz IMMW PPDU and duplicate over each 320 MHz if the IMMW PPDU bandwidth is wider than 320 MHz. The IMMW-LTF is optional if MIMO is not used and the number of IMMW-LTF will be indicated in the U-SIG or IMMW-SIG.

The benefit of using 1× or 2×HE-LTF design is to mitigate the phase noise effect on the channel estimation. upclock existing 20 MHz 1× or 2× or 4×HE-LTF by 16 times for 320 MHz IMMW PPDU and duplicate over each 320 MHz, which will resulting in 0.8 μs/1.6 μs/3.2 μs two LTF symbols plus GI which can be ¼, ½ or 100% if 1× or 2×HE-LTF is used to mitigate the phase noise effect.

U-SIG/IMMW-SIG: U-SIG/IMMW-SIG will be transmitted with 256 802.11ax tone plan and duplicated over each 320 MHz if the IMMW PPDU bandwidth is wider than 320 MHz. 256 802.11ac tone plan can also be used. But, 802.11ax tone plan is more efficient.

Note: The U-SIG and IMMW-SIG will be used to carry length field, mcs, coding bit if multiple coding types are going to be used for IMMW data PPDU, these coding types may include BSS, legacy LDPC and 2×LDPC, LDPC extra symbol field if LDPC with 802.11 ac LDPC rate matching is used, DL/UL, PHY version, BSS color, STA-ID, PPDU type, TXOP, GI+LTF size and number of IMMW-LTFs, number of Fine sector search fields, which can be but not limited to in terms of number of sectors, best sector ID feedback from the receiver to the transmitter based on the fine sector search result in current PPDU transmission, scrambling seed information and etc. These fields can be separated into version independent and version dependent fields, and the U-SIG and IMMW-SIG maybe can be combined as one SIG field. The scrambling seed can be also carried in the U-SIG or IMMW-SIG to improve the reliability.

IMMW-STF: upclock existing legacy STF by 4 times and duplicate over each 80 MHz, which resulting in 10 times of 0.2 μs periodicity. It may need to shorter with less time repetition, such as 5 times of 0.2 μs periodicity.

Fine sector search: this is for Beamforming refining/tuning sector search, which can alternate sector STFs and the number of symbols is indicated in the IMMW-SIG field.

IMMW-LTF: upclock existing 20 MHz 1× or 2× or 4×HE-LTF by 16 times for 320 MHz IMMW PPDU and duplicate over each 320 MHz. The IMMW-LTF is optional if MIMO is not used.

Note: minimum 8 μs is required between the end of U-SIG/IMMW-SIG and the beginning of the first DATA symbol, which is similar to sub-8 GHz case, where there is minimum 8 μs between the end of EHT/UHR-SIG and the beginning of the first DATA symbol. This time duration can be used for fine sector search or to transmit more IMMW-LTFs for more accurate channel estimation. The minimum duration may be a smaller number.

It is understood that the above descriptions are for the purposes of illustration and are not meant to be limiting.

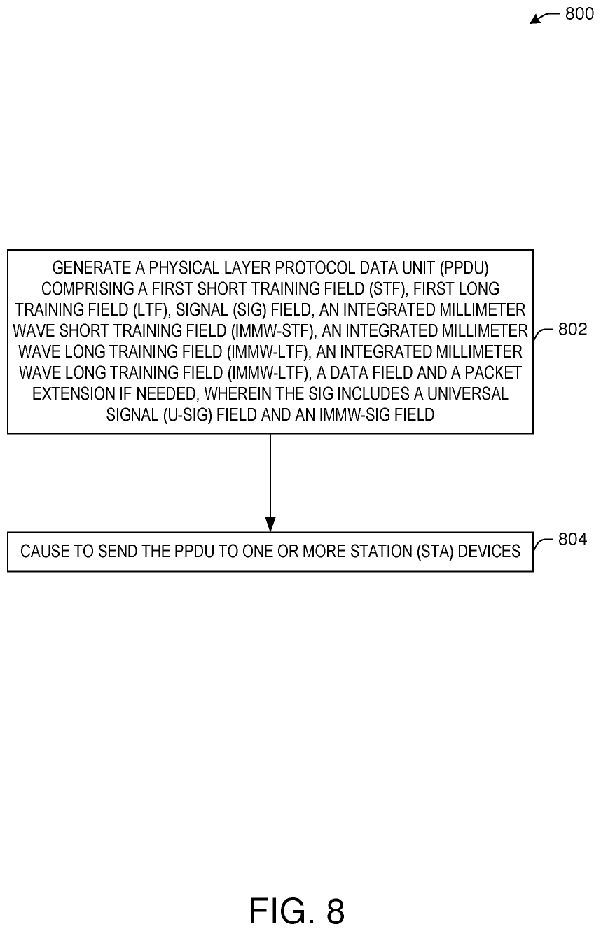

FIG. 8 illustrates a flow of illustrative process 800 for an optimized PPDU format system, in accordance with one or more example embodiments of the present disclosure.

At block 802, a device (e.g., the user device(s) 120 and/or the AP 102 of FIG. 1 and/or the optimized PPDU format device 1019 of FIG. 10) may generate a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG includes a Universal Signal (U-SIG) field and an IMMW-SIG field.

At block 804, the device may cause to send the PPDU to one or more station (STA) devices.

It is understood that the above descriptions are for the purposes of illustration and are not meant to be limiting.

FIG. 9 shows a functional diagram of an exemplary communication station 900, in accordance with one or more example embodiments of the present disclosure. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (e.g., a speaker), a optimized PPDU format device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1002 for generation and processing of the baseband signals and for controlling operations of the main memory 1004, the storage device 1016, and/or the optimized PPDU format device 1019. The baseband processor may be provided on a single radio card, a single chip, or an integrated circuit (IC).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The optimized PPDU format device 1019 may carry out or perform any of the operations and processes (e.g., process 800) described and shown above.

It is understood that the above are only a subset of what the optimized PPDU format device 1019 may be configured to perform and that other functions included throughout this disclosure may also be performed by the optimized PPDU format device 1019.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

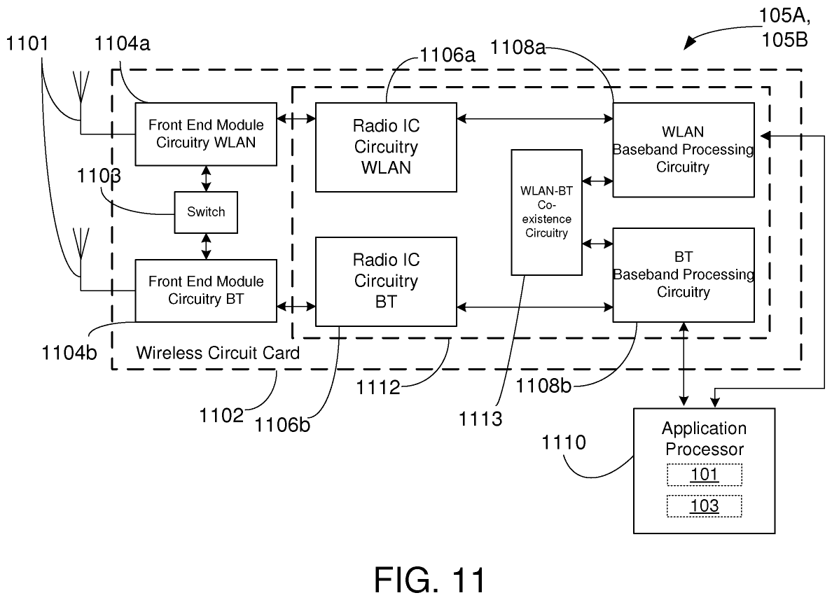

FIG. 11 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1104a-b, radio IC circuitry 1106a-b and baseband processing circuitry 1108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1104a-b may include a WLAN or Wi-Fi FEM circuitry 1104a and a Bluetooth (BT) FEM circuitry 1104b. The WLAN FEM circuitry 1104a may include a receive signal path comprising circuitry configured to operate on WLAN RF signals received from one or more antennas 1101, to amplify the received signals and to provide the amplified versions of the received signals to the WLAN radio IC circuitry 1106a for further processing. The BT FEM circuitry 1104b may include a receive signal path which may include circuitry configured to operate on BT RF signals received from one or more antennas 1101, to amplify the received signals and to provide the amplified versions of the received signals to the BT radio IC circuitry 1106b for further processing. FEM circuitry 1104a may also include a transmit signal path which may include circuitry configured to amplify WLAN signals provided by the radio IC circuitry 1106a for wireless transmission by one or more of the antennas 1101. In addition, FEM circuitry 1104b may also include a transmit signal path which may include circuitry configured to amplify BT signals provided by the radio IC circuitry 1106b for wireless transmission by the one or more antennas. In the embodiment of FIG. 11, although FEM 1104a and FEM 1104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1106a-b as shown may include WLAN radio IC circuitry 1106a and BT radio IC circuitry 1106b. The WLAN radio IC circuitry 1106a may include a receive signal path which may include circuitry to down-convert WLAN RF signals received from the FEM circuitry 1104a and provide baseband signals to WLAN baseband processing circuitry 1108a. BT radio IC circuitry 1106b may in turn include a receive signal path which may include circuitry to down-convert BT RF signals received from the FEM circuitry 1104b and provide baseband signals to BT baseband processing circuitry 1108b. WLAN radio IC circuitry 1106a may also include a transmit signal path which may include circuitry to up-convert WLAN baseband signals provided by the WLAN baseband processing circuitry 1108a and provide WLAN RF output signals to the FEM circuitry 1104a for subsequent wireless transmission by the one or more antennas 1101. BT radio IC circuitry 1106b may also include a transmit signal path which may include circuitry to up-convert BT baseband signals provided by the BT baseband processing circuitry 1108b and provide BT RF output signals to the FEM circuitry 1104b for subsequent wireless transmission by the one or more antennas 1101. In the embodiment of FIG. 11, although radio IC circuitries 1106a and 1106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1108a-b may include a WLAN baseband processing circuitry 1108a and a BT baseband processing circuitry 1108b. The WLAN baseband processing circuitry 1108a may include a memory, such as, for example, a set of RAM arrays in a Fast Fourier Transform or Inverse Fast Fourier Transform block (not shown) of the WLAN baseband processing circuitry 1108a. Each of the WLAN baseband circuitry 1108a and the BT baseband circuitry 1108b may further include one or more processors and control logic to process the signals received from the corresponding WLAN or BT receive signal path of the radio IC circuitry 1106a-b, and to also generate corresponding WLAN or BT baseband signals for the transmit signal path of the radio IC circuitry 1106a-b. Each of the baseband processing circuitries 1108a and 1108b may further include physical layer (PHY) and medium access control layer (MAC) circuitry, and may further interface with a device for generation and processing of the baseband signals and for controlling operations of the radio IC circuitry 1106a-b.

Referring still to FIG. 11, according to the shown embodiment, WLAN-BT coexistence circuitry 1113 may include logic providing an interface between the WLAN baseband circuitry 1108a and the BT baseband circuitry 1108b to enable use cases requiring WLAN and BT coexistence. In addition, a switch 1103 may be provided between the WLAN FEM circuitry 1104a and the BT FEM circuitry 1104b to allow switching between the WLAN and BT radios according to application needs. In addition, although the antennas 1101 are depicted as being respectively connected to the WLAN FEM circuitry 1104a and the BT FEM circuitry 1104b, embodiments include within their scope the sharing of one or more antennas as between the WLAN and BT FEMs, or the provision of more than one antenna connected to each of FEM 1104a or 1104b.

In some embodiments, the front-end module circuitry 1104a-b, the radio IC circuitry 1106a-b, and baseband processing circuitry 1108a-b may be provided on a single radio card, such as wireless radio card 1102. In some other embodiments, the one or more antennas 1101, the FEM circuitry 1104a-b and the radio IC circuitry 1106a-b may be provided on a single radio card. In some other embodiments, the radio IC circuitry 1106a-b and the baseband processing circuitry 1108a-b may be provided on a single chip or integrated circuit (IC), such as IC 1112.

In some embodiments, the wireless radio card 1102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 11, the BT baseband circuitry 1108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

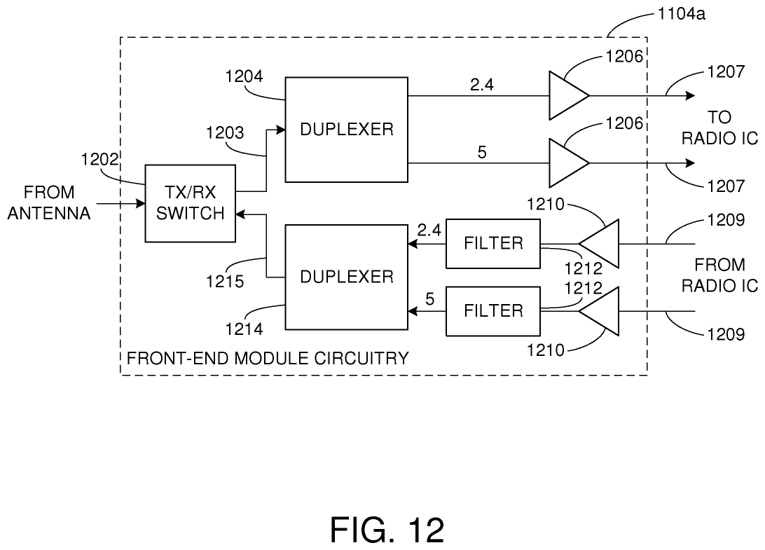

FIG. 12 illustrates WLAN FEM circuitry 1104a in accordance with some embodiments. Although the example of FIG. 12 is described in conjunction with the WLAN FEM circuitry 1104a, the example of FIG. 12 may be described in conjunction with the example BT FEM circuitry 1104b (FIG. 11), although other circuitry configurations may also be suitable.

In some embodiments, the FEM circuitry 1104a may include a TX/RX switch 1202 to switch between transmit mode and receive mode operation. The FEM circuitry 1104a may include a receive signal path and a transmit signal path. The receive signal path of the FEM circuitry 1104a may include a low-noise amplifier (LNA) 1206 to amplify received RF signals 1203 and provide the amplified received RF signals 1207 as an output (e.g., to the radio IC circuitry 1106a-b (FIG. 11)). The transmit signal path of the circuitry 1104a may include a power amplifier (PA) to amplify input RF signals 1209 (e.g., provided by the radio IC circuitry 1106a-b), and one or more filters 1212, such as band-pass filters (BPFs), low-pass filters (LPFs) or other types of filters, to generate RF signals 1215 for subsequent transmission (e.g., by one or more of the antennas 1101 (FIG. 11)) via an example duplexer 1214.

In some dual-mode embodiments for Wi-Fi communication, the FEM circuitry 1104a may be configured to operate in either the 2.4 GHz frequency spectrum or the 5 GHz frequency spectrum. In these embodiments, the receive signal path of the FEM circuitry 1104a may include a receive signal path duplexer 1204 to separate the signals from each spectrum as well as provide a separate LNA 1206 for each spectrum as shown. In these embodiments, the transmit signal path of the FEM circuitry 1104a may also include a power amplifier 1210 and a filter 1212, such as a BPF, an LPF or another type of filter for each frequency spectrum and a transmit signal path duplexer 1204 to provide the signals of one of the different spectrums onto a single transmit path for subsequent transmission by the one or more of the antennas 1101 (FIG. 11). In some embodiments, BT communications may utilize the 2.4 GHz signal paths and may utilize the same FEM circuitry 1104a as the one used for WLAN communications.

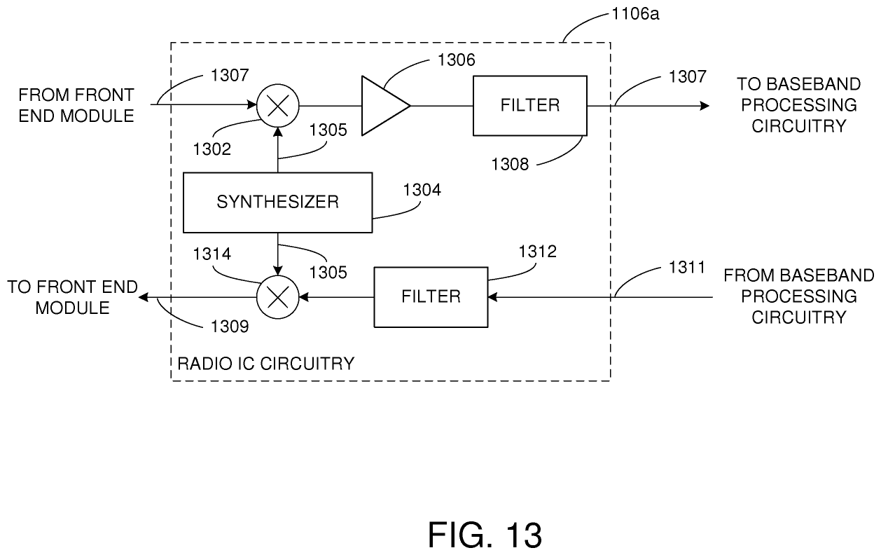

FIG. 13 illustrates radio IC circuitry 1106a in accordance with some embodiments. The radio IC circuitry 1106a is one example of circuitry that may be suitable for use as the WLAN or BT radio IC circuitry 1106a/1106b (FIG. 11), although other circuitry configurations may also be suitable. Alternatively, the example of FIG. 13 may be described in conjunction with the example BT radio IC circuitry 1106b.

In some embodiments, the radio IC circuitry 1106a may include a receive signal path and a transmit signal path. The receive signal path of the radio IC circuitry 1106a may include at least mixer circuitry 1302, such as, for example, down-conversion mixer circuitry, amplifier circuitry 1306 and filter circuitry 1308. The transmit signal path of the radio IC circuitry 1106a may include at least filter circuitry 1312 and mixer circuitry 1314, such as, for example, up-conversion mixer circuitry. Radio IC circuitry 1106a may also include synthesizer circuitry 1304 for synthesizing a frequency 1305 for use by the mixer circuitry 1302 and the mixer circuitry 1314. The mixer circuitry 1302 and/or 1314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 13 illustrates only a simplified version of a radio IC circuitry, and may include, although not shown, embodiments where each of the depicted circuitries may include more than one component. For instance, mixer circuitry 1314 may each include one or more mixers, and filter circuitries 1308 and/or 1312 may each include one or more filters, such as one or more BPFs and/or LPFs according to application needs. For example, when mixer circuitries are of the direct-conversion type, they may each include two or more mixers.

In some embodiments, mixer circuitry 1302 may be configured to down-convert RF signals 1207 received from the FEM circuitry 1104a-b (FIG. 11) based on the synthesized frequency 1305 provided by synthesizer circuitry 1304. The amplifier circuitry 1306 may be configured to amplify the down-converted signals and the filter circuitry 1308 may include an LPF configured to remove unwanted signals from the down-converted signals to generate output baseband signals 1307. Output baseband signals 1307 may be provided to the baseband processing circuitry 1108a-b (FIG. 11) for further processing. In some embodiments, the output baseband signals 1307 may be zero-frequency baseband signals, although this is not a requirement. In some embodiments, mixer circuitry 1302 may comprise passive mixers, although the scope of the embodiments is not limited in this respect.

In some embodiments, the mixer circuitry 1314 may be configured to up-convert input baseband signals 1311 based on the synthesized frequency 1305 provided by the synthesizer circuitry 1304 to generate RF output signals 1209 for the FEM circuitry 1104a-b. The baseband signals 1311 may be provided by the baseband processing circuitry 1108a-b and may be filtered by filter circuitry 1312. The filter circuitry 1312 may include an LPF or a BPF, although the scope of the embodiments is not limited in this respect.

In some embodiments, the mixer circuitry 1302 and the mixer circuitry 1314 may each include two or more mixers and may be arranged for quadrature down-conversion and/or up-conversion respectively with the help of synthesizer 1304. In some embodiments, the mixer circuitry 1302 and the mixer circuitry 1314 may each include two or more mixers each configured for image rejection (e.g., Hartley image rejection). In some embodiments, the mixer circuitry 1302 and the mixer circuitry 1314 may be arranged for direct down-conversion and/or direct up-conversion, respectively. In some embodiments, the mixer circuitry 1302 and the mixer circuitry 1314 may be configured for super-heterodyne operation, although this is not a requirement.

Mixer circuitry 1302 may comprise, according to one embodiment: quadrature passive mixers (e.g., for the in-phase (I) and quadrature phase (Q) paths). In such an embodiment, RF input signal 1207 from FIG. 13 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1305 of synthesizer 1304 (FIG. 13). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1207 (FIG. 12) may comprise a balanced signal, although the scope of the embodiments is not limited in this respect. The I and Q baseband output signals may be provided to low-noise amplifier, such as amplifier circuitry 1306 (FIG. 13) or to filter circuitry 1308 (FIG. 13).

In some embodiments, the output baseband signals 1307 and the input baseband signals 1311 may be analog baseband signals, although the scope of the embodiments is not limited in this respect. In some alternate embodiments, the output baseband signals 1307 and the input baseband signals 1311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1304 may be a fractional-N synthesizer or a fractional N/N+1 synthesizer, although the scope of the embodiments is not limited in this respect as other types of frequency synthesizers may be suitable. For example, synthesizer circuitry 1304 may be a delta-sigma synthesizer, a frequency multiplier, or a synthesizer comprising a phase-locked loop with a frequency divider. According to some embodiments, the synthesizer circuitry 1304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1304 may be provided by a voltage controlled oscillator (VCO), although that is not a requirement. A divider control input may further be provided by either the baseband processing circuitry 1108a-b (FIG. 11) depending on the desired output frequency 1305. In some embodiments, a divider control input (e.g., N) may be determined from a look-up table (e.g., within a Wi-Fi card) based on a channel number and a channel center frequency as determined or indicated by the example application processor 1110. The application processor 1110 may include, or otherwise be connected to, one of the example secure signal converter 101 or the example received signal converter 103 (e.g., depending on which device the example radio architecture is implemented in).

In some embodiments, synthesizer circuitry 1304 may be configured to generate a carrier frequency as the output frequency 1305, while in other embodiments, the output frequency 1305 may be a fraction of the carrier frequency (e.g., one-half the carrier frequency, one-third the carrier frequency). In some embodiments, the output frequency 1305 may be a LO frequency (fLO).

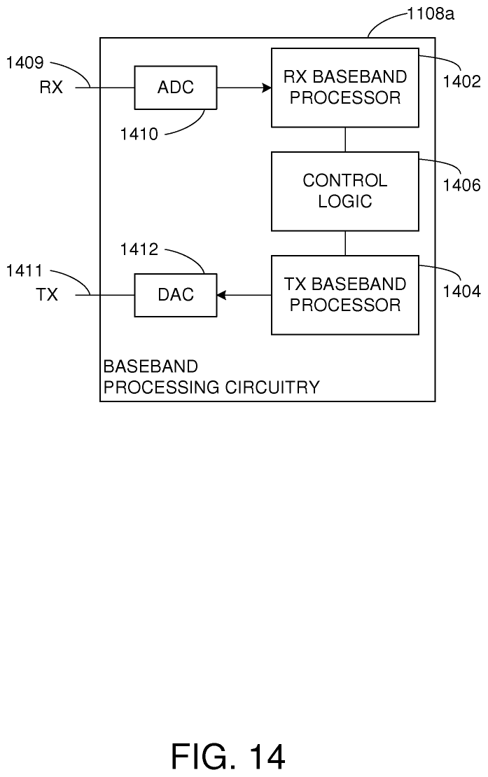

FIG. 14 illustrates a functional block diagram of baseband processing circuitry 1108a in accordance with some embodiments. The baseband processing circuitry 1108a is one example of circuitry that may be suitable for use as the baseband processing circuitry 1108a (FIG. 11), although other circuitry configurations may also be suitable. Alternatively, the example of FIG. 13 may be used to implement the example BT baseband processing circuitry 1108b of FIG. 11.

The baseband processing circuitry 1108a may include a receive baseband processor (RX BBP) 1402 for processing receive baseband signals 1309 provided by the radio IC circuitry 1106a-b (FIG. 11) and a transmit baseband processor (TX BBP) 1404 for generating transmit baseband signals 1311 for the radio IC circuitry 1106a-b. The baseband processing circuitry 1108a may also include control logic 1406 for coordinating the operations of the baseband processing circuitry 1108a.

In some embodiments (e.g., when analog baseband signals are exchanged between the baseband processing circuitry 1108a-b and the radio IC circuitry 1106a-b), the baseband processing circuitry 1108a may include ADC 1410 to convert analog baseband signals 1409 received from the radio IC circuitry 1106a-b to digital baseband signals for processing by the RX BBP 1402. In these embodiments, the baseband processing circuitry 1108a may also include DAC 1412 to convert digital baseband signals from the TX BBP 1404 to analog baseband signals 1411.

In some embodiments that communicate OFDM signals or OFDMA signals, such as through baseband processor 1108a, the transmit baseband processor 1404 may be configured to generate OFDM or OFDMA signals as appropriate for transmission by performing an inverse fast Fourier transform (IFFT). The receive baseband processor 1402 may be configured to process received OFDM signals or OFDMA signals by performing an FFT. In some embodiments, the receive baseband processor 1402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 11, in some embodiments, the antennas 1101 (FIG. 11) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: generate a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG may include a Universal Signal (U-SIG) field and an IMMW-SIG field; and cause to send the PPDU to one or more station (STA) devices.

Example 2 may include the device of example 1 and/or some other example(s) herein, wherein a total duration of the IMMW-STF and the IMMW-LTF may be approximately 8 microseconds (psec), and wherein the IMMW-LTF may be equivalent to an upclocked version of an existing 20 MHz or 40 MHz 1×, 2×, or 4×HE-LTF, scaled by a factor of 16 for 320 MHz or 640 MHz IMMW PPDU.

Example 3 may include the device of example 1 and/or some other example(s) herein, wherein the U-SIG and the IMMW-SIG field may include a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO may be supported in IMMW.

Example 4 may include the device of example 3 and/or some other example(s) herein, wherein the U-SIG indicates the MCS and a number of OFDM symbols in the IMMW-SIG field.

Example 5 may include the device of example 1 and/or some other example(s) herein, wherein the processing circuitry may be further configured to duplicate the first STF, the first LTF, the U-SIG or IMMW-SIG every 320 MHz within a bandwidth.

Example 6 may include the device of example 1 and/or some other example(s) herein, wherein the IMMW-SIG field may be transmitted using a fixed MCS capable of being identical to an MCS of the U-SIG field, or a configurable MCS indicated in the U-SIG.

Example 7 may include the device of example 1 and/or some other example(s) herein, wherein the first LTF, the U-SIG, IMMW-SIG, use a 20 MHz U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth may be larger than 320 Mhz.

Example 8 may include the device of example 1 and/or some other example(s) herein, wherein the data field may be mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

Example 9 may include the device of example 1 and/or some other example(s) herein, wherein the processing circuitry may be further configured to map an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L may be a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

Example 10 may include the device of example 9 and/or some other example(s) herein, wherein the processing circuitry may be further configured to cause to upclock existing legacy 20 MHz LTF with the LTF sequence, L_{-26, 26}, by 4 times and duplicate over each 80 MHz resulting in a 2 μs duration, as the first LTF.

Example 11 may include a non-transitory computer-readable medium storing computer-executable instructions which when executed by one or more processors result in performing operations comprising: generating a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG may include a Universal Signal (U-SIG) field and an IMMW-SIG field; and causing to send the PPDU to one or more station (STA) devices.

Example 12 may include the non-transitory computer-readable medium of example 11 and/or some other example(s) herein, wherein a total duration of the IMMW-STF and the IMMW-LTF may be approximately 8 microseconds (psec), and wherein the IMMW-LTF may be equivalent to an upclocked version of an existing 20 MHz or 40 MHz 1×, 2×, or 4×HE-LTF, scaled by a factor of 16 for 320 MHz or 640 MHz IMMW PPDU.

Example 13 may include the non-transitory computer-readable medium of example 11 and/or some other example(s) herein, wherein the U-SIG and the IMMW-SIG field may include a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO may be supported in IMMW.

Example 14 may include the non-transitory computer-readable medium of example 13 and/or some other example(s) herein, wherein the U-SIG indicates the MCS and a number of OFDM symbols in the IMMW-SIG field.

Example 15 may include the non-transitory computer-readable medium of example 11 and/or some other example(s) herein, wherein the operations further comprise duplicating the first STF, the first LTF, the U-SIG or IMMW-SIG every 320 MHz within a bandwidth.

Example 16 may include the non-transitory computer-readable medium of example 11 and/or some other example(s) herein, wherein the IMMW-SIG field may be transmitted using a fixed MCS capable of being identical to an MCS of the U-SIG field, or a configurable MCS indicated in the U-SIG.

Example 17 may include the non-transitory computer-readable medium of example 11 and/or some other example(s) herein, wherein the first LTF, the U-SIG, IMMW-SIG, use a 20 MHz U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth may be larger than 320 Mhz.

Example 18 may include the non-transitory computer-readable medium of example 11 and/or some other example(s) herein, wherein the data field may be mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

Example 19 may include the non-transitory computer-readable medium of example 11 and/or some other example(s) herein, wherein the operations further comprise mapping an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L may be a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

Example 20 may include the non-transitory computer-readable medium of example 19 and/or some other example(s) herein, wherein the operations further comprise causing to upclock existing legacy 20 MHz LTF with the LTF sequence, L_{-26, 26}, by 4 times and duplicate over each 80 MHz resulting in a 2 μs duration, as the first LTF.

Example 21 may include a method comprising: generating a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG may include a Universal Signal (U-SIG) field and an IMMW-SIG field; and causing to send the PPDU to one or more station (STA) devices.

Example 22 may include the method of example 21 and/or some other example(s) herein, wherein a total duration of the IMMW-STF and the IMMW-LTF may be approximately 8 microseconds (psec), and wherein the IMMW-LTF may be equivalent to an upclocked version of an existing 20 MHz or 40 MHz 1×, 2×, or 4×HE-LTF, scaled by a factor of 16 for 320 MHz or 640 MHz IMMW PPDU.

Example 23 may include the method of example 21 and/or some other example(s) herein, wherein the U-SIG and the IMMW-SIG field may include a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO may be supported in IMMW.

Example 24 may include the method of example 23 and/or some other example(s) herein, wherein the U-SIG indicates the MCS and a number of OFDM symbols in the IMMW-SIG field.

Example 25 may include the method of example 21 and/or some other example(s) herein, the method further comprising duplicating the first STF, the first LTF, the U-SIG or IMMW-SIG every 320 MHz within a bandwidth.

Example 26 may include the method of example 21 and/or some other example(s) herein, wherein the IMMW-SIG field may be transmitted using a fixed MCS capable of being identical to an MCS of the U-SIG field, or a configurable MCS indicated in the U-SIG.

Example 27 may include the method of example 21 and/or some other example(s) herein, wherein the first LTF, the U-SIG, IMMW-SIG, use a 20 MHz U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth may be larger than 320 Mhz.

Example 28 may include the method of example 21 and/or some other example(s) herein, wherein the data field may be mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

Example 29 may include the method of example 21 and/or some other example(s) herein, the method further comprising mapping an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L may be a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

Example 30 may include the method of example 29 and/or some other example(s) herein, the method further comprising causing to upclock existing legacy 20 MHz LTF with the LTF sequence, L_{-26, 26}, by 4 times and duplicate over each 80 MHz resulting in a 2 μs duration, as the first LTF.

Example 31 may include an apparatus comprising means for: generating a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG may include a Universal Signal (U-SIG) field and an IMMW-SIG field; and causing to send the PPDU to one or more station (STA) devices.

Example 32 may include the apparatus of example 31 and/or some other example(s) herein, wherein a total duration of the IMMW-STF and the IMMW-LTF may be approximately 8 microseconds (psec), and wherein the IMMW-LTF may be equivalent to an upclocked version of an existing 20 MHz or 40 MHz 1×, 2×, or 4×HE-LTF, scaled by a factor of 16 for 320 MHz or 640 MHz IMMW PPDU.

Example 33 may include the apparatus of example 31 and/or some other example(s) herein, wherein the U-SIG and the IMMW-SIG field may include a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO may be supported in IMMW.

Example 34 may include the apparatus of example 33 and/or some other example(s) herein, wherein the U-SIG indicates the MCS and a number of OFDM symbols in the IMMW-SIG field.

Example 35 may include the apparatus of example 31 and/or some other example(s) herein, further comprising duplicating the first STF, the first LTF, the U-SIG or IMMW-SIG every 320 MHz within a bandwidth.

Example 36 may include the apparatus of example 31 and/or some other example(s) herein, wherein the IMMW-SIG field may be transmitted using a fixed MCS capable of being identical to an MCS of the U-SIG field, or a configurable MCS indicated in the U-SIG.

Example 37 may include the apparatus of example 31 and/or some other example(s) herein, wherein the first LTF, the U-SIG, IMMW-SIG, use a 20 MHz U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth may be larger than 320 Mhz.

Example 38 may include the apparatus of example 31 and/or some other example(s) herein, wherein the data field may be mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

Example 39 may include the apparatus of example 31 and/or some other example(s) herein, further comprising mapping an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L may be a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

Example 40 may include the apparatus of example 39 and/or some other example(s) herein, further comprising causing to upclock existing legacy 20 MHz LTF with the LTF sequence, L_{-26, 26}, by 4 times and duplicate over each 80 MHz resulting in a 2 μs duration, as the first LTF.

Example 41 may include one or more non-transitory computer-readable media comprising instructions to cause an electronic device, upon execution of the instructions by one or more processors of the electronic device, to perform one or more elements of a method described in or related to any of examples 1-38, or any other method or process described herein.

Example 42 may include an apparatus comprising logic, modules, and/or circuitry to perform one or more elements of a method described in or related to any of examples 1-38, or any other method or process described herein.

Example 43 may include a method, technique, or process as described in or related to any of examples 1-38, or portions or parts thereof.

Example 44 may include an apparatus comprising: one or more processors and one or more computer readable media comprising instructions that, when executed by the one or more processors, cause the one or more processors to perform the method, techniques, or process as described in or related to any of examples 1-38, or portions thereof.

Example 45 may include a method of communicating in a wireless network as shown and described herein.

Example 46 may include a system for providing wireless communication as shown and described herein.

Example 47 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
generate a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG includes a Universal Signal (U-SIG) field and an IMMW-SIG field; and
cause to send the PPDU to one or more station (STA) devices.

2. The device of claim 1, wherein a total duration of the IMMW-STF and the IMMW-LTF is approximately 8 microseconds (psec), and wherein the IMMW-LTF is equivalent to an upclocked version of an existing 20 MHz or 40 MHz 1×, 2×, or 4×HE-LTF, scaled by a factor of 16 for 320 MHz or 640 MHz IMMW PPDU.

3. The device of claim 1, wherein the U-SIG and the IMMW-SIG field includes a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO is supported in IMMW.

4. The device of claim 3, wherein the U-SIG indicates the MCS and a number of OFDM symbols in the IMMW-SIG field.

5. The device of claim 1, wherein the processing circuitry is further configured to duplicate the first STF, the first LTF, the U-SIG or IMMW-SIG every 320 MHz within a bandwidth.

6. The device of claim 1, wherein the IMMW-SIG field is transmitted using a fixed MCS capable of being identical to an MCS of the U-SIG field, or a configurable MCS indicated in the U-SIG.

7. The device of claim 1, wherein the first LTF, the U-SIG, IMMW-SIG, use a 20 MHz L-LTF or U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth is larger than 320 Mhz.

8. The device of claim 1, wherein the data field is mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

9. The device of claim 1, wherein the processing circuitry is further configured to map an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L is a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

10. The device of claim 9, wherein the processing circuitry is further configured to cause to upclock existing legacy 20 MHz LTF with the LTF sequence, L_{-26, 26}, by 4 times and duplicate over each 80 MHz resulting in a 2 μs duration, as the first LTF.

11. A non-transitory computer-readable medium storing computer-executable instructions which when executed by one or more processors result in performing operations comprising:
generating a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG includes a Universal Signal (U-SIG) field and an IMMW-SIG field; and
causing to send the PPDU to one or more station (STA) devices.

12. The non-transitory computer-readable medium of claim 11, wherein a total duration of the IMMW-STF and the IMMW-LTF is approximately 8 microseconds (psec), and wherein the IMMW-LTF is equivalent to an upclocked version of an existing 20 MHz or 40 MHz 1×, 2×, or 4×HE-LTF, scaled by a factor of 16 for 320 MHz or 640 MHz IMMW PPDU.

13. The non-transitory computer-readable medium of claim 11, wherein the U-SIG and the IMMW-SIG field includes a bandwidth field indicating a bandwidth of 320 MHz or 640 MHz, a length field (same as that in L-SIG or as number of OFDM symbols), modulation and coding scheme (MCS), a coding bit, an LDPC extra symbol, 2×LDPC, an STA ID, a UL/DL, a BSS color, a PPDU type (SU PPDU or NDP), a TXOP, a GI, a number of LTFs, a scrambling seed, a spatial configuration if MIMO is supported in IMMW.

14. The non-transitory computer-readable medium of claim 13, wherein the U-SIG indicates the MCS and a number of OFDM symbols in the IMMW-SIG field.

15. The non-transitory computer-readable medium of claim 11, wherein the operations further comprise duplicating the first STF, the first LTF, the U-SIG or IMMW-SIG every 320 MHz within a bandwidth.

16. The non-transitory computer-readable medium of claim 11, wherein the IMMW-SIG field is transmitted using a fixed MCS capable of being identical to an MCS of the U-SIG field, or a configurable MCS indicated in the U-SIG.

17. The non-transitory computer-readable medium of claim 11, wherein the first LTF, the U-SIG, IMMW-SIG, use a 20 MHz L-LTF or U-SIG tone plan over sub-7 GHz and duplicate over each 80 MHz in IMMW PPDU, or use a VHT 40 MHz tone plan and duplicate the fields over each 160 MHz in the IMMW PPDU, or use an HE/EHT 256 tone plan and duplicate the fields over each 320 MHz in the IMMW PPDU if a bandwidth is larger than 320 Mhz.

18. The non-transitory computer-readable medium of claim 11, wherein the data field is mapped to a 256-point or 512-point Fast Fourier Transform (FFT) non-Orthogonal Frequency Division Multiple Access (non-OFDMA) EHT tone plan with 1.25 MHz subcarrier spacing for 320 or 640 MHz IMMW PPDU data transmission.

19. The non-transitory computer-readable medium of claim 11, wherein the operations further comprise mapping an LTF sequence over each 80 MHz of a 320 MHz transmission such that subcarriers indexed from −26 to −2 and from 2 to 26 are modulated by elements of a Long (L) sequence and other subcarriers have a value of zero, and wherein the sequence L is a 53-element sequence given by L_{-26, 26}={1, 1, −1, −1, 1, 1, −1, 1, −1, 1, 1, 1, 1, 1, 1, −1, −1, 1, 1, −1, 1, −1, 1, 1, 1, 1, 0, 1, −1, −1, 1, 1, −1, 1, −1, 1, −1, −1, −1, −1, −1, 1, 1, −1, −1, 1, −1, 1, −1, 1, 1, 1, 1}.

20. A method comprising:
generating a Physical Layer Protocol Data Unit (PPDU) comprising a first short training field (STF), first long training field (LTF), signal (SIG) field, an Integrated Millimeter Wave Short Training Field (IMMW-STF), an Integrated Millimeter Wave Long Training Field (IMMW-LTF), an Integrated Millimeter Wave Long Training Field (IMMW-LTF), a data field and a packet extension if needed, wherein the SIG includes a Universal Signal (U-SIG) field and an IMMW-SIG field; and
causing to send the PPDU to one or more station (STA) devices.
